(19) United States
(12) Patent Application Publication
(10) Pub. No.: US 2018/0234598 A9
(43) Pub. Date: Aug. 16, 2018

(54) Motion Capture Camera with Illuminated Status Ring

(71) Applicant: NaturalPoint, Inc., Corvallis, OR (US)

(72) Inventors: James D. RICHARDSON, Corvallis, OR (US); William F. HAYES, Philomath, OR (US); Mark B. Rossmeier, Albany, OR (US)

(73) Assignee: NaturalPoint, Inc.

(21) Appl. No.: 14/454,248

(22) Filed: Aug. 7, 2014

Related U.S. Application Data
(60) Provisional application No. 61/863,396, filed on Aug. 7, 2013.

(51) Int. Cl. H04N 5/225; H04N 5/247; F21V 33/00; H04N 5/232

(52) U.S. Cl. CPC H04N 5/2256; H04N 5/232; F21V 33/0052; H04N 5/247

(57) ABSTRACT

A motion capture camera or motion capture system having a plurality of such cameras located around a motion capture volume where the camera includes an illuminated color-coded status ring that, under computer and/or manual control, visually communicates at a glance a status of the camera and/or system to an operator within the motion capture volume.

This patent application claims, pursuant to 35 USC 119, the benefit of U.S. Provisional Patent Application Ser. No. 61/863,396, filed on Aug. 7, 2013, now pending, the entire contents of which are hereby expressly incorporated by reference.

### BACKGROUND OF THE INVENTION

1. Field of the Invention

This application relates generally to a motion capture camera and, more particularly, to a motion capture camera with an illuminated status ring and a system comprising a plurality of such cameras. In such a system, each camera preferably includes an illuminated color-coded camera status ring that, under computer and/or manual control, visually communicates a status of the camera and/or system to an operator.

2. Description of the Prior Art

Motion capture systems often use a plurality of cameras and associated motion capture software to record the movement of objects or people. In the filmmaking and videogame industries, special reflective markers are often attached to the actors and then the actors perform, as required, by moving about on a stage, or so-called volume, that is surrounded by cameras and associated lights for illuminating the reflective markers. A typical motion capture camera includes an integrated package containing a light source, an image sensor, a lens, an on-board processor, and a network interface port. A common light source is a ring of IR (infrared) or NIR (near infrared) LEDs that surround the camera lens for evenly illuminating the reflective markers that are imaged by the lens onto the camera's digital sensor.

In a typical situation, many such cameras are physically connected to trusses and are electrically connected by a network interface port (e.g. an Ethernet port) to a nearby computer that is running the motion capture software used to control the cameras and receive the motion capture data from the cameras.

It is important to know the real-time status of the system. For example, the actors need to be informed that the system is about to start, or has in fact, began recording motion; the motion capture equivalent of a traditional director yelling, “lights, camera, action.” Prior to the present invention, it has been relatively difficult for the actors to readily know the status of the system from just a glance.

It is also important under certain circumstances to be able to identify a particular camera. Prior to the present invention, the cameras were typically labeled with numbers and on-stage operators were verbally alerted to which camera required attention. In other words, a first attendant would tell a second attendant working within the volume that camera “24” needs attention (e.g. to be re-positioned), and then the second attendant would identify camera “24” by visually, painstakingly searching for that particular number amongst a sea of otherwise identical looking cameras. This is a slow, error-prone task.

There remains a need, therefore, for a motion capture camera and related system comprised of many such cameras that quickly and effectively communicates the status of the overall system or of each individual camera.

### BRIEF DESCRIPTION OF THE DRAWINGS

FIG. 1 is a perspective view of a presently preferred motion capture camera 10 containing an illuminated, color-coded status ring 50 according to a first preferred embodiment of the invention;

FIG. 2 is a perspective view of the first preferred camera 10 of FIG. 1;

FIG. 3 is an exploded perspective view of the first preferred camera 10 of FIG. 1 with its cover plate 22 removed to more clearly reveal the diffusion ring 51 of the illuminated status ring 50;

FIG. 4 is an exploded perspective view of the first preferred camera 10 of FIG. 1 with its cover plate 22 and its diffusion ring 51 separated from the remainder of the camera 10 to clearly reveal sixteen RGB LEDs 52 that are covered by the diffusion ring 51 when fully assembled

FIG. 5 is a front view of the first preferred camera 10 with its cover plate removed to show the diffusion ring 51;

FIG. 6 is a front elevational view of the first preferred camera of FIG. 5 with the diffusion ring 51 removed to reveal the RGB LEDs 52.

FIG. 7 shows a typical motion capture system comprising a screen view of exemplary motion capture software (e.g. OptiTrack's “Motive”™ platform) that controls a plurality of motion capture cameras (28 are shown) arranged around a volume;

FIG. 8 is a close-up view of a “Camera Status Ring” panel within exemplary motion capture software for allowing a user to customize the camera status ring for different systems states in terms of both intensity and color mixture (e.g. Live Color 0; 2; 4=low-intensity greenish-blue , Recording Color 10; 0; 0=bright red, and Playback Color 0; 0; 0=off or “black”), and for a manual selection state (e.g. Selection Color 50; 30; 0=bright yellow);

FIG. 9 is a perspective view of a motion capture stage 100 with its truss structure 110 and associated cameras 10, most of which have a bluish-colored status ring, with a particular one of the cameras 10** manually placed into a “selected” state that features a bright yellow camera status ring for efficient and rapid location relative to the other cameras;

FIG. 10 is a schematic diagram of the sixteen surface-mount LEDs 52 used in the preferred embodiment, D1 to D16 (Part No. APTF1616SEEZGQBDC, from Kingbright);

FIG. 11 is a schematic diagram of step-down regular (part no. ST1S10 from STMicroelectronics) and associated support components that provide power to the LEDS 52 of FIG. 10;

FIG. 12 is a schematic diagram of the LED controllers U5, U6, and U7 (PCA9532 LED dimmers made by NXP Semiconductors), the associated wiring, and the associated current-limiting resistors, used to control the on/off/blinking status and/or intensity of the red, green, and blue portions of the RGB LEDs 52 making up the illuminated status ring 50; and

FIGS. 13, 14, 15, and 16 illustrate the presently preferred colors for a “live” status, a “recording” status, a “playback” status, and a camera “selection” status, respectively.

### DETAILED DESCRIPTION OF THE PREFERRED EMBODIMENTS

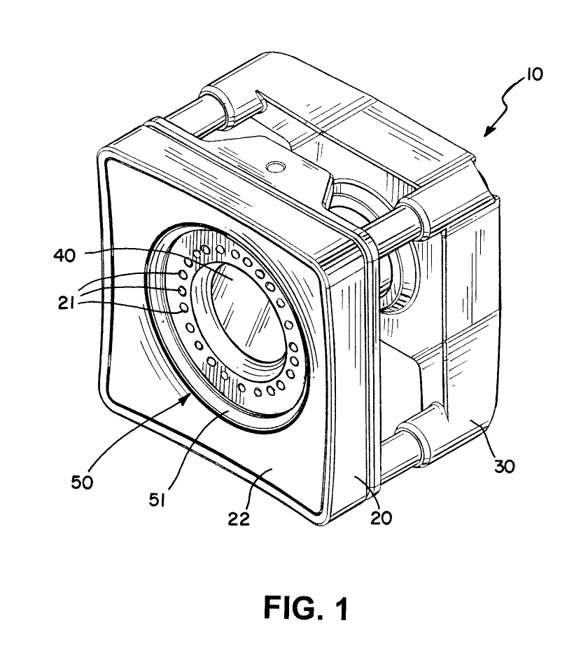

FIG. 1 shows a presently preferred motion capture (“mocap”) camera 10 that is formed from a main body (not separately numbered) having a front portion 20 and a back portion 30. A lens 40 is provided for focusing an image onto a sensor (not shown) contained in the back portion 30. In this particular camera, the front portion 20 supports the objective side of the lens 40, along with an illumination source for illuminating reflective subject markers located on actors or objects that are moved within the volume. The illumination source may provide any suitable frequency of light that is now or may be in future use (e.g. 680 nm red light, 720 or 780 IR or Near IR, UV light, blue light, etc.). A common source of illumination in current use comprises a plurality of infrared LEDs 21 that illuminate the subject (e.g. reflective markers on an actor's body suit or on an object). A front panel 22 surrounds the lens 40 and exposes the infrared LEDs 21 so that they can illuminate the motion capture markers.

FIG. 1 further shows that the preferred mocap camera 10 comprises, of particular significance to the present patent application, includes a status display 50 that faces forward with the camera's lens 40 and is easily viewed from all areas that may be imaged by the lens or, in other words, from within substantially all parts of the motion capture volume. The preferred status display is color coded for immediately communicating each camera's status at a glance and, when desired, for visually differentiating a camera's status relative to other cameras.

In a first preferred embodiment of the invention, as shown in FGI. 1, the status display 50 comprises an illuminated status ring 50 that provides a color-coded status display. In this embodiment, the status ring 50 comprises a diffusion ring 51 that has a frosted, beveled surface and is arranged concentrically with the axis of the lens 40 and the infrared illumination LEDs 21.

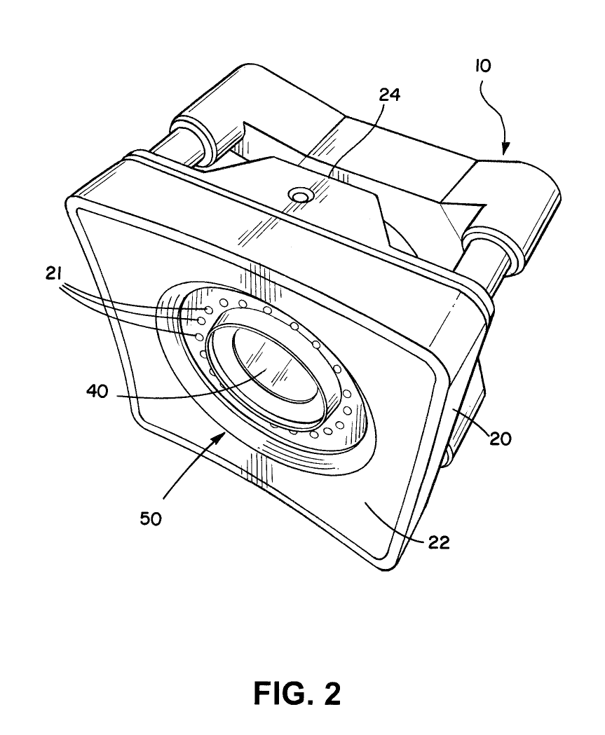

FIG. 2 is a perspective photographic view of the first preferred camera 10 of FIG. 1. As shown here, the front portion 20 includes mounting plates 24 (one top and bottom) that provide standard ¼-20 holes for mounting the camera about the periphery of a volume, usually to a suitable truss structure.

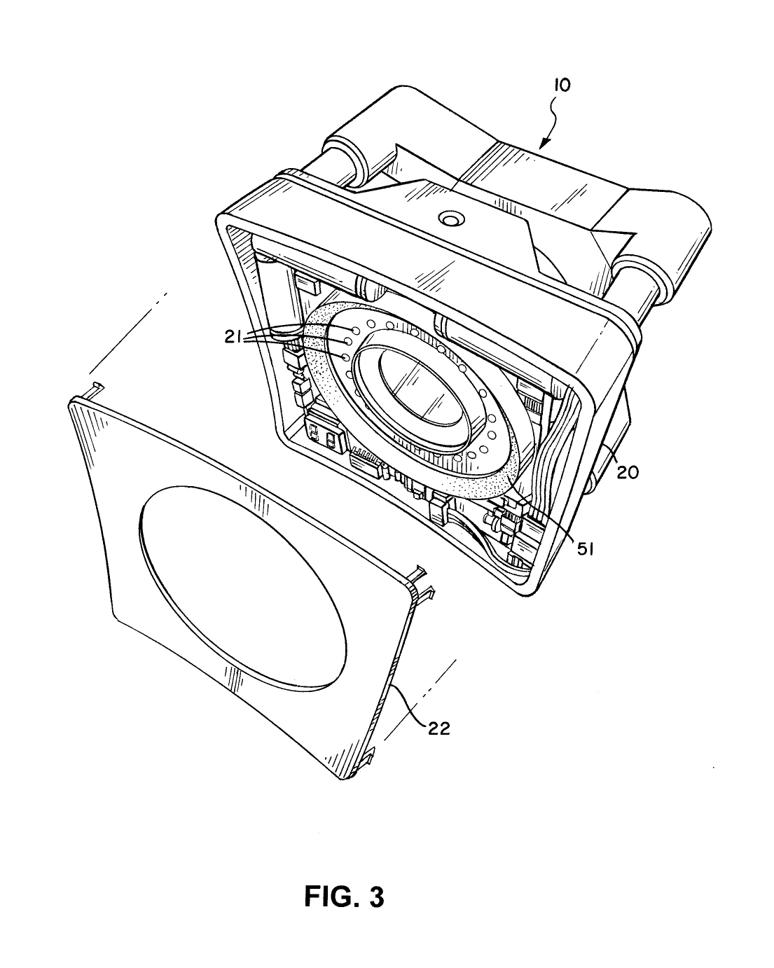

FIG. 3 is an exploded perspective view of the first preferred camera 10 of FIG. 1 with its cover plate 22 removed to more clearly reveal the diffusion ring 51 of the illuminated status ring 50.

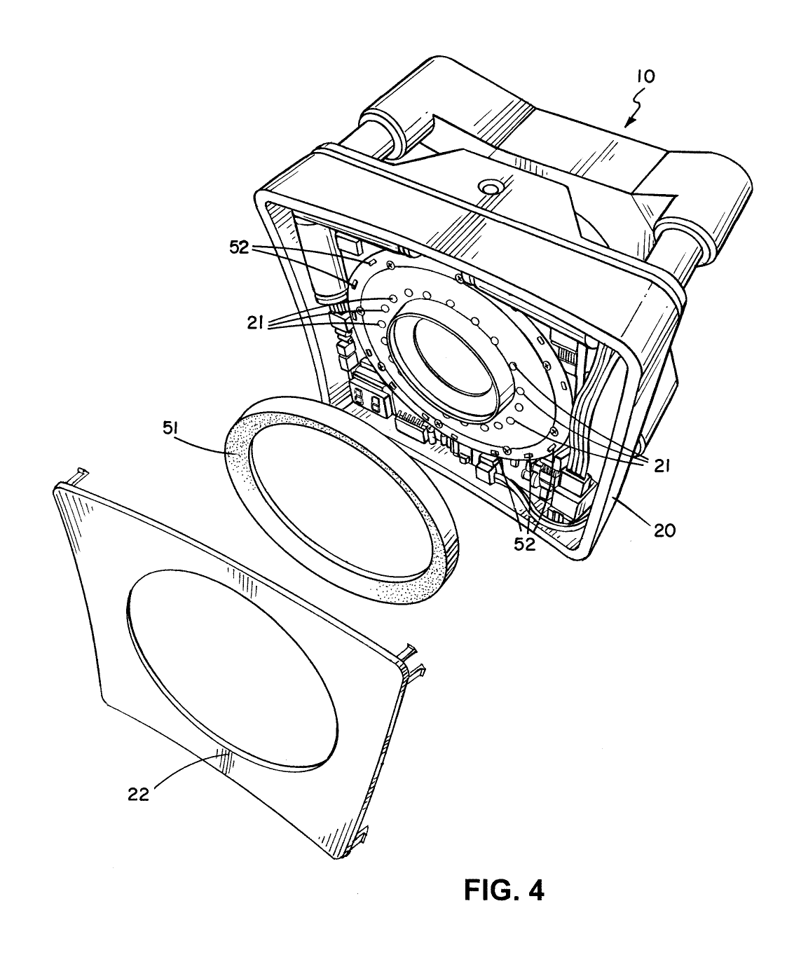

FIG. 4 is a further exploded perspective view of the first preferred camera 10 of FIG. 3 with its cover plate 22 and now its diffusion ring 51 separated from the remainder of the camera 10 to reveal, in this embodiment, sixteen RGB LEDs 52 (surface mount packages) that are located on the PCBA contained within the front portion 20. The preferred diffusion ring 51 is made of a suitable plastic and preferably has a roughened surface on forward facing side for diffusing light transmitted through the ring. As suggested by FIG. 4, the diffusion ring 51 snaps into place and overlays the sixteen RGB LEDs 52 and, owing to its opaque white color and roughened light-diffusing surface, thoroughly blends the colored light emitted by the sixteen discrete LEDs 52 so that diffusion ring 51 itself appears to be a single, annular source of colored light.

The preferred status ring 50, formed from the diffusion ring 51 and the underlying RGB LEDs 52, is concentric with the lens 40, and with the existing illumination LEDs 21, so that they are readily and quickly ascertained by an observer trying to ascertain the status of a particular camera, or so that an observer can quickly ascertain the status of the overall motion capture system.

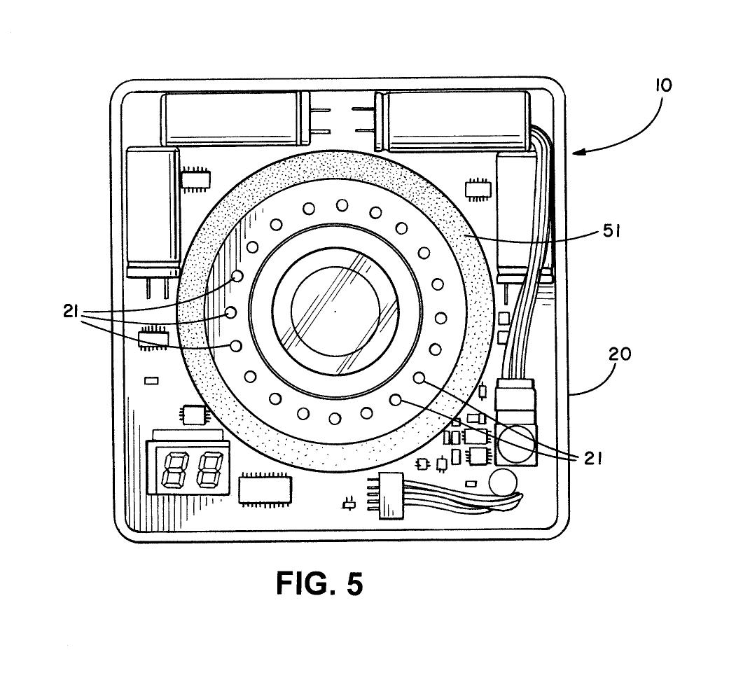

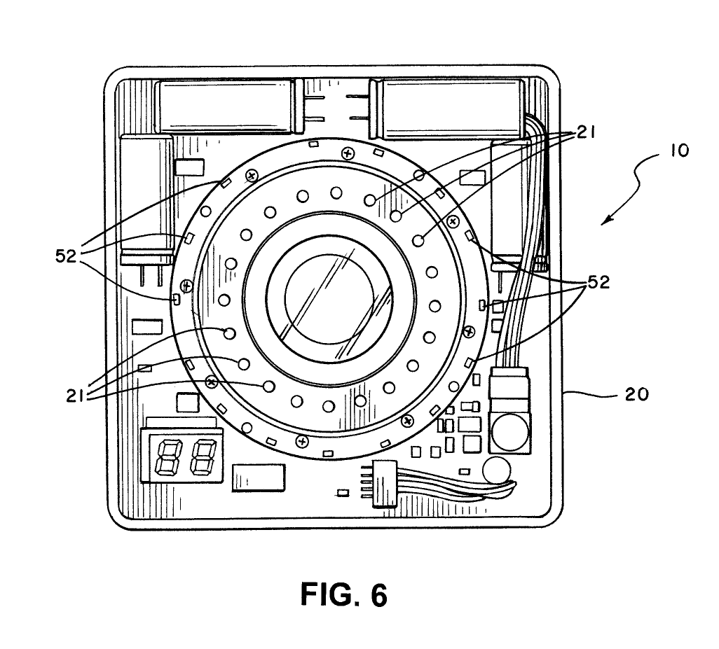

FIGS. 5 and 6 further illustrate the preferred embodiment. FIG. 5 is a front view of the first preferred camera 10 with its cover plate 22 (see FIG. 4) removed to show the beveled front of the preferred diffusion ring 51. FIG. 6 is a front elevational view of the first preferred camera 10 with the diffusion ring 51 further removed to reveal the multi-die LEDs 52 that each contain a red, green and blue element for computer-controlled color mixing.

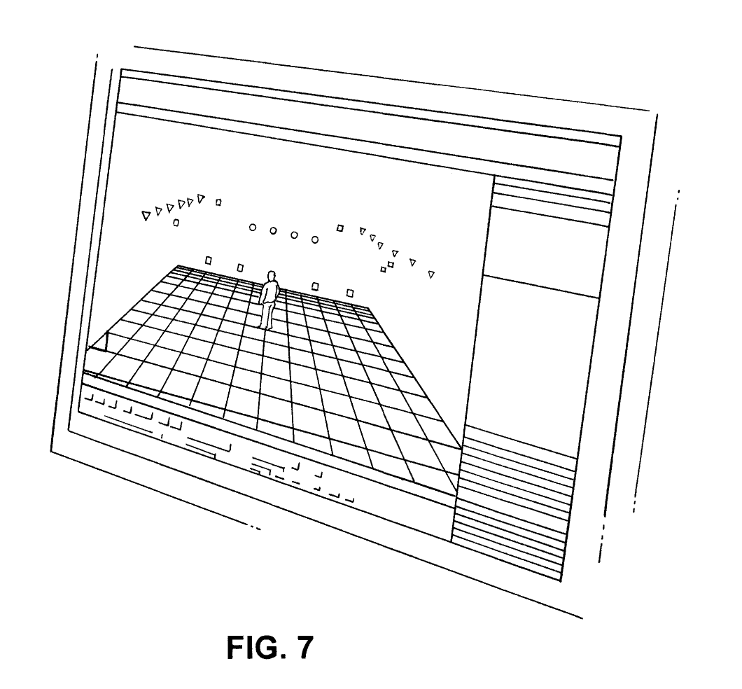

FIG. 7 shows a typical motion capture system comprising a screen view of exemplary motion capture software that controls and processes motion capture data from a plurality of motion capture cameras arranged around a volume. Assignee OptiTrack's “Motive”™ platform is an example of such a software system. In this particular case, the software offers a 3D capture volume visualization feature that displays a 3D view of 29 motion capture cameras 10 that are arranged around the perimeter of a volume. In the preferred embodiment, the “Motive”™ software has been uniquely modified to communicate with the illuminated status ring 50 of each motion capture camera 10.

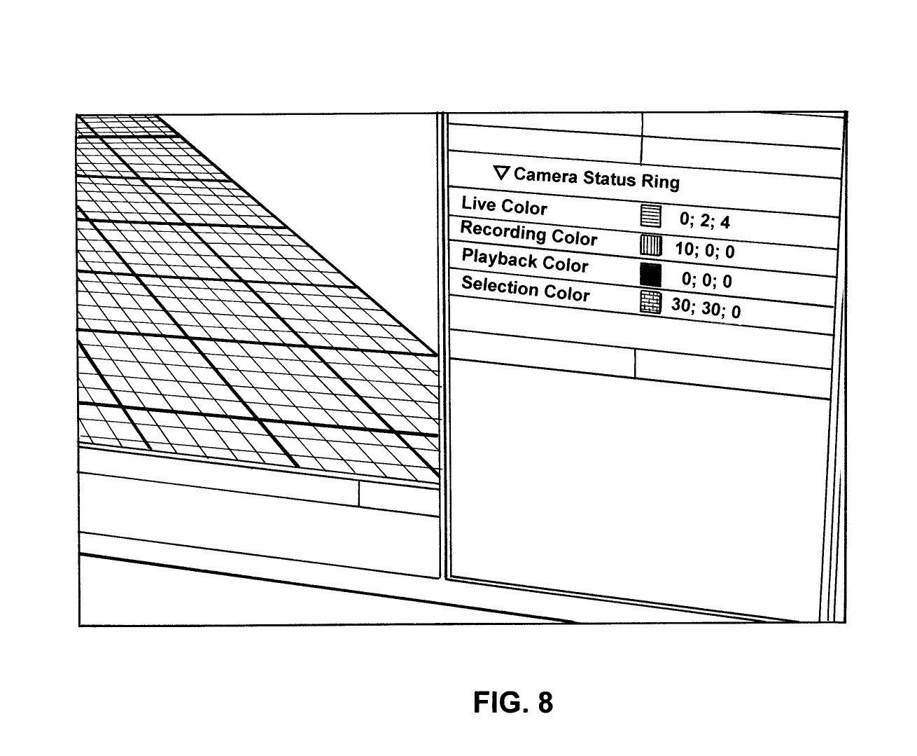

In particular, FIG. 8 is a close-up view of a currently preferred “Camera Status Ring” panel that is made available to the user within the motion capture software for allowing the user to customize the color of the camera status rings 50 for different system states in terms of both intensity and color mixture (e.g. Live Color 0; 2; 4=low-intensity greenish-blue , Recording Color 10; 0; 0=bright red, and Playback Color 0; 0; 0=off or “black”), and for a manual selection state (e.g. Selection Color 50; 30; 0=bright yellow). The low intensity levels are often preferred for the status displays because of the relatively low light levels of visible light that are often present.

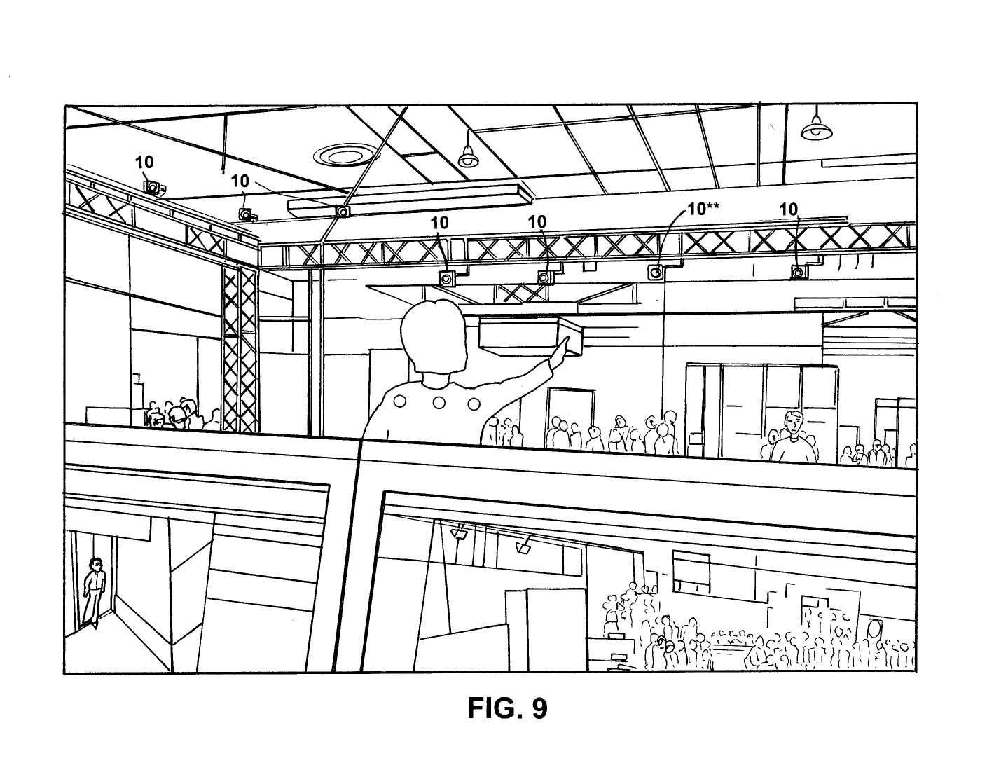

FIG. 9 is a perspective view of a computer screen running the “Motive”™ software, along with a motion capture stage 100 in the background including a motion capture volume formed by an overhead truss structure 110 and associated cameras 10. In the example shown, most of the cameras 10 have a bluish-colored status ring which indicates that the system and associated cameras are “live”, while at the same time, a particular one of the cameras 10** has been manually placed into a “selected” state that features a bright yellow camera status ring for efficient and rapid location relative to the other cameras.

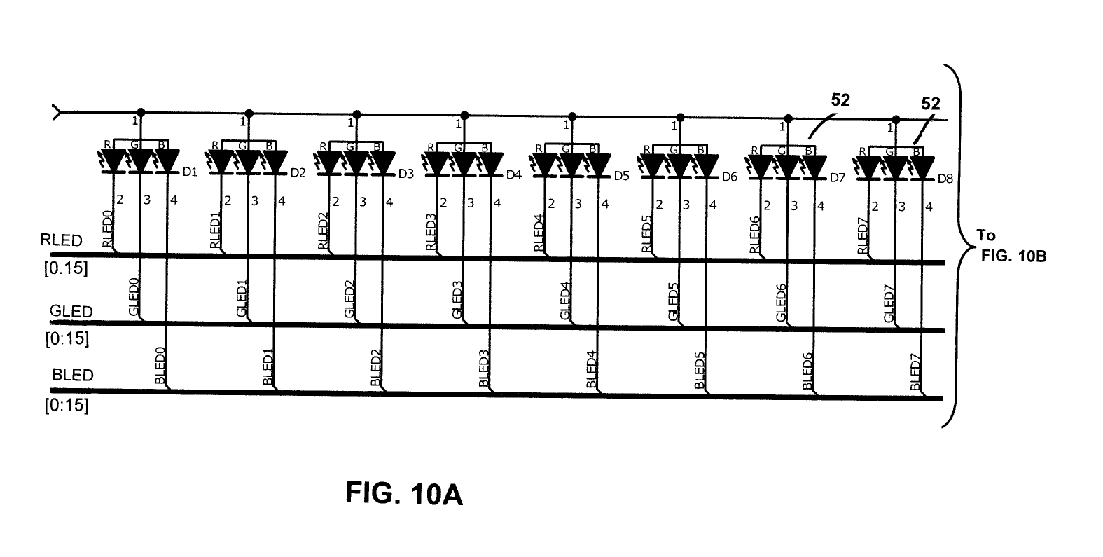

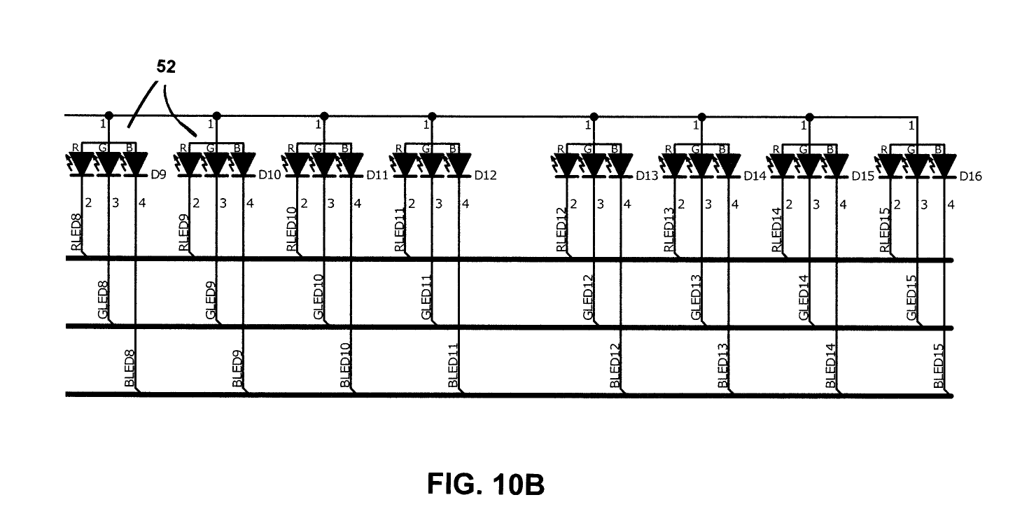

While many different circuits may be implemented, FIGS. 10 to 12 illustrate the presently preferred control circuitry for changing one of the on/off state, intensity, and color of the illuminated status ring to communicate a state of the camera 10 or system containing the camera 10.

FIG. 10 is a schematic diagram of the sixteen LEDs 52 used in the preferred embodiment, D1 to D16. The preferred LEDs 52 are surface-mount

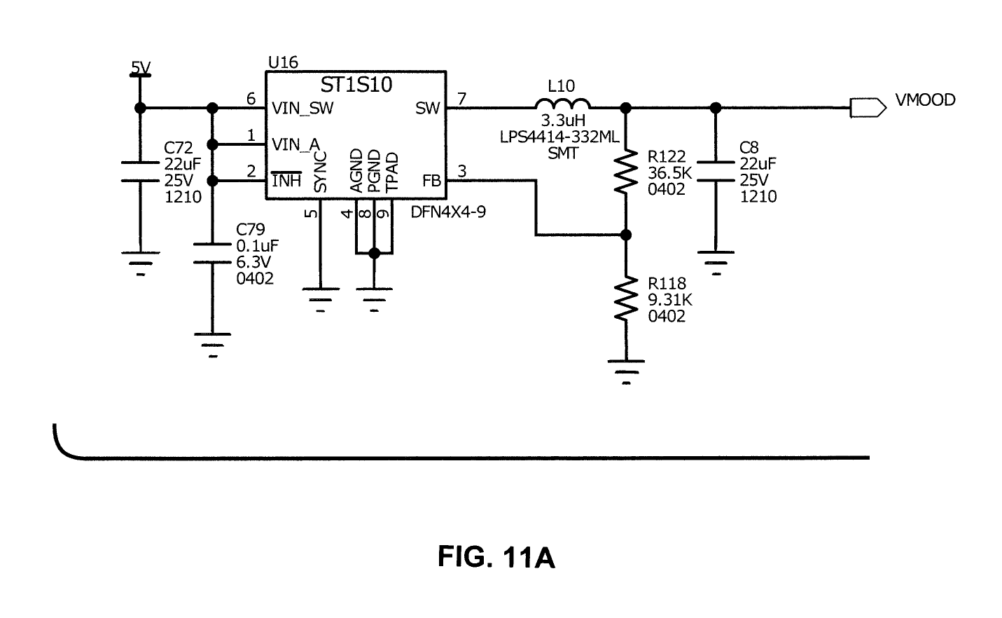

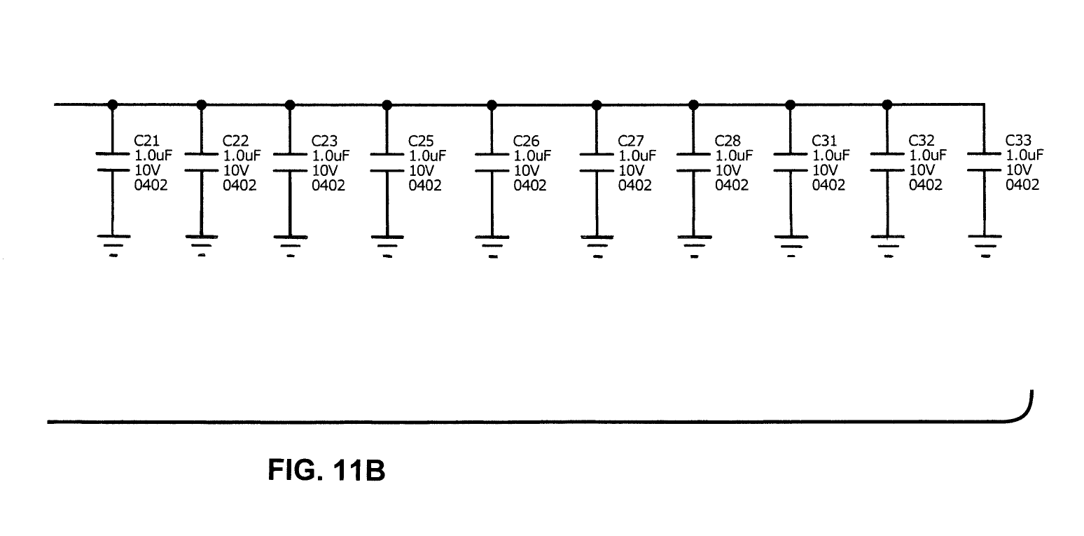

FIG. 11 is a schematic diagram of step-down regular (part no. ST1S10 from STMicroelectronics) and associated support components that provide power to the LEDS 52 of FIG. 10.

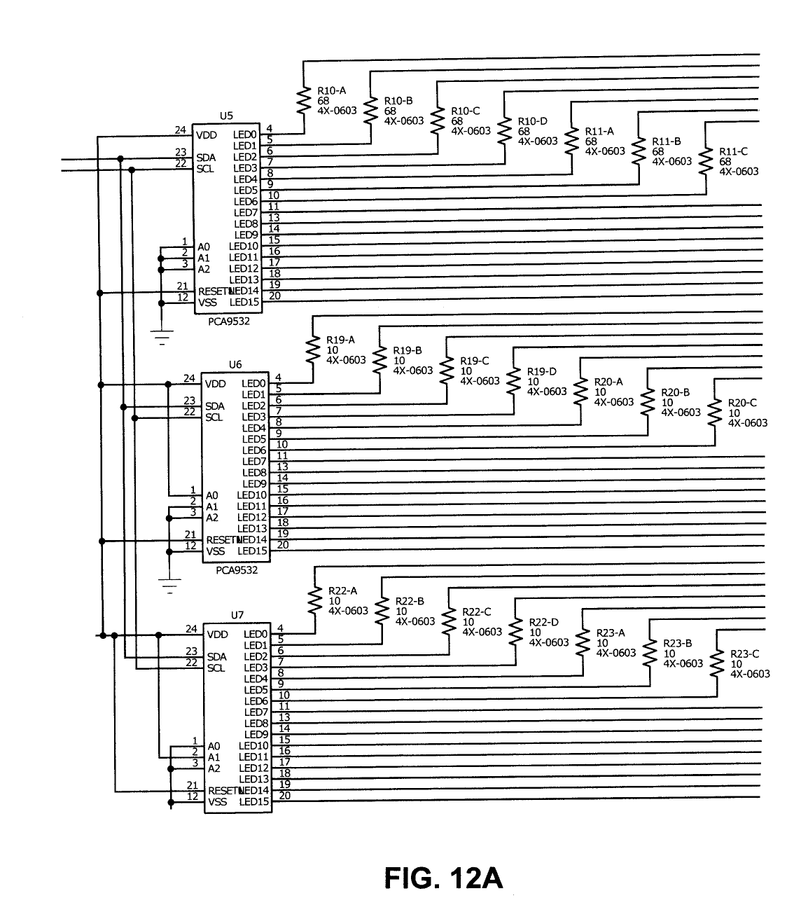

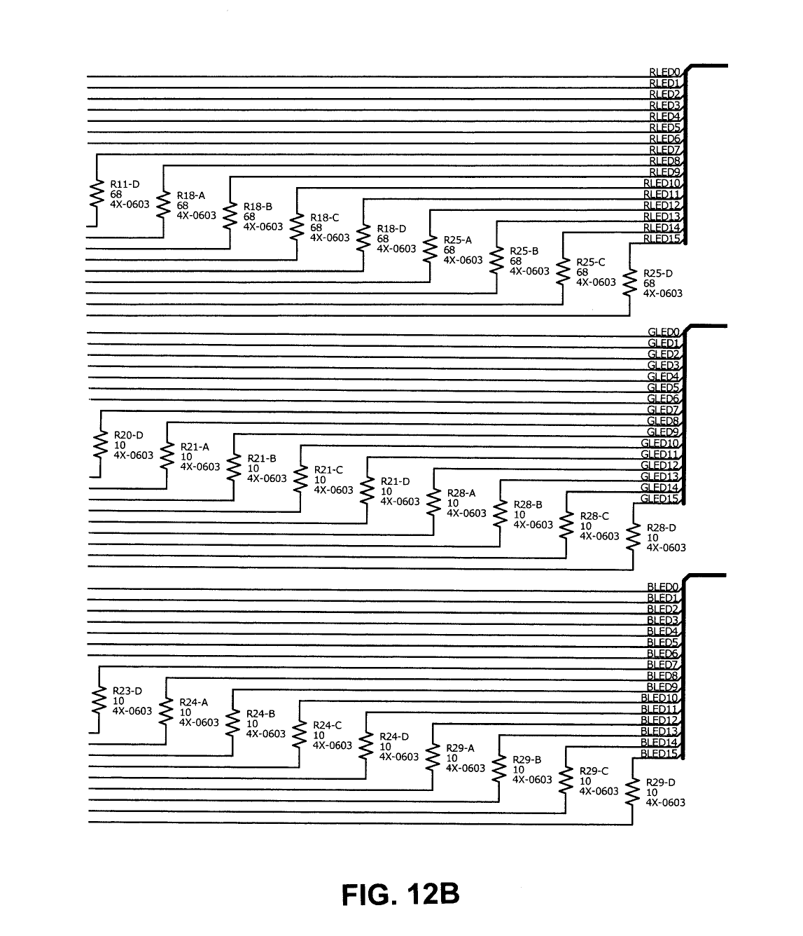

FIG. 12 is a schematic diagram of the LED controllers U5, U6, and U7 (PCA9532 LED dimmers made by NXP Semiconductors), the associated wiring, and the associated current-limiting resistors, used to control the on/off/blinking status and/or intensity of the red, green, and blue portions of the RGB LEDs 52 making up the illuminated status ring 50.

The description above has described a motion capture system that, through suitable software and the associated network architecture, communicates the overall system's status through the cameras 10. This permits ready communication to all of the system status including, for example, whether or not the motion capture system is in live, recording, or playback mode.

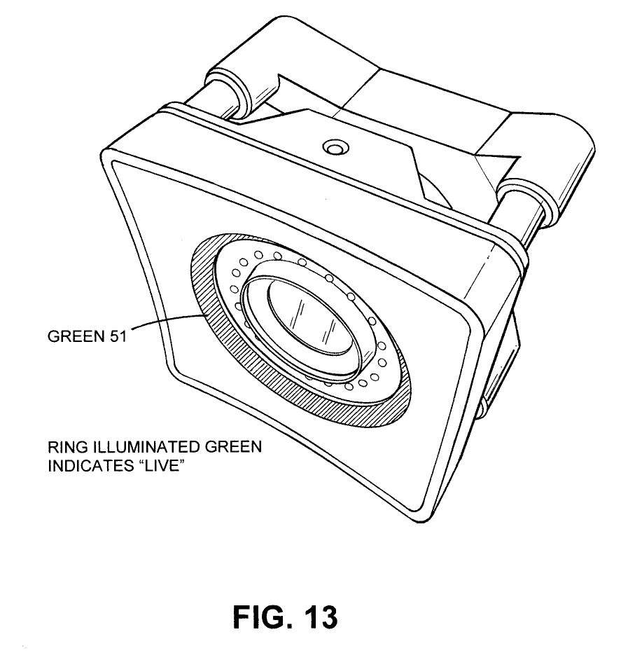

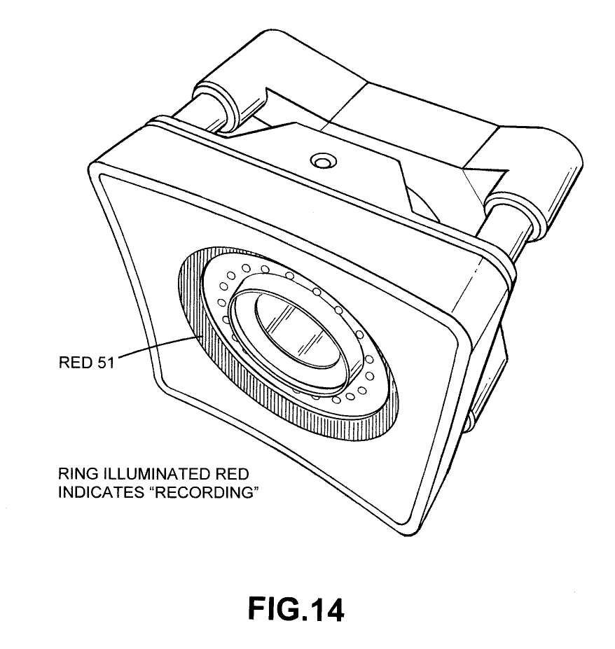

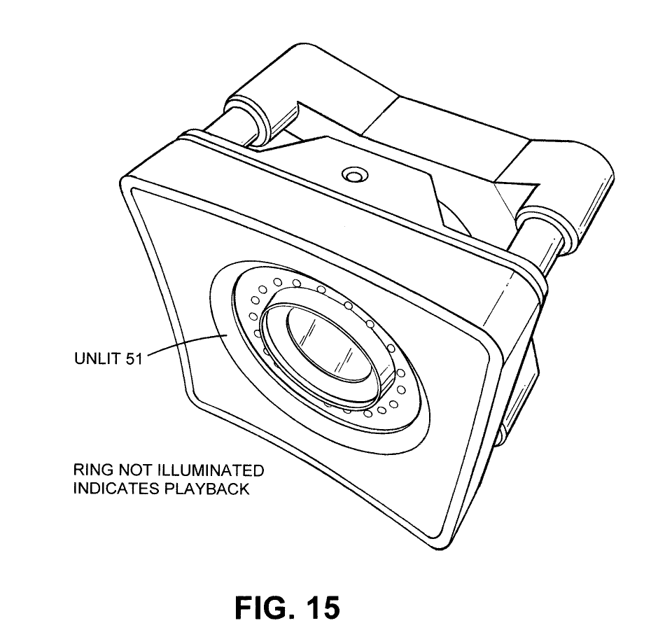

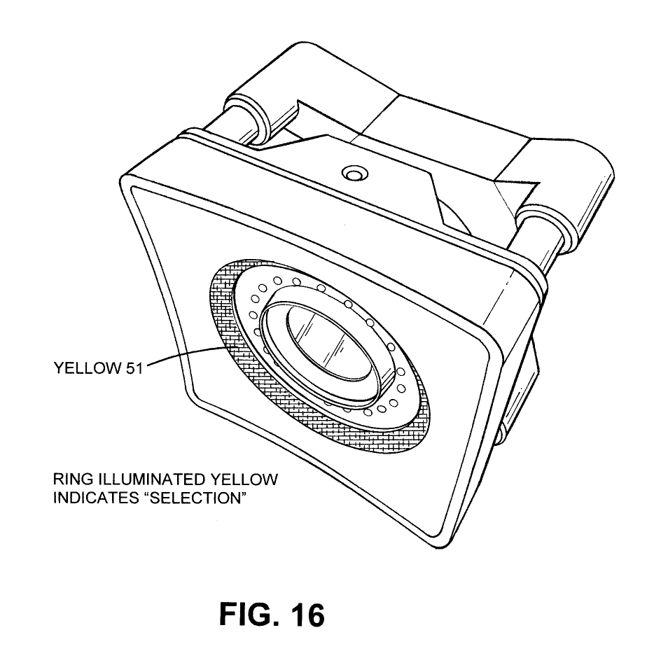

FIGS. 13, 14, 15, and 16 illustrate the presently preferred colors for a “live” status, a “recording” status, a “playback” status, and a camera “selection” status, respectively. The drawings show solid, steady colors, but it is also possible to animate the discrete LEDs behind the status ring, to have them flash, chase one another, etc.

In addition, the processors in the individual cameras can independently control the associated status ring 50. This allows the status, as determined by the camera's on-board processor, to quickly and effectively communicate with the users. For example, an error of some sort that has been detected by the camera's processor can be communicated through the status ring (e.g. flashing red). Or, during a firmware update which can take several minutes or more, the status ring 50 can communicate that the update is still proceeding by flashing and/or progressively growing larger in a progress-bar manner.

The status ring 50 is particularly useful during motion capture preparation which requires calibration of each camera after the volume is assembled or after any camera movement. Prior to being used for motion capture, for example, the cameras are typically calibrated through a process called “wanding” where an operator puts the software in calibration mode by clicking a “start wanding” button and then moves about the volume while waiving a wand (e.g. “OptiWand”™) having markers (e.g. three ¾ markers) supported in a spaced distance from one another (e.g. 250 mm and 50 mm). In the control system presently used, the software's calibration engine will begin recording samples as soon as the calibration wand is detected. The primary goal during calibration is to maximize coverage, both in the 2D camera view of each camera and also throughout the desired physical capture volume. The operator manipulating the wand within the volume does not stop “wanding” until sufficient coverage has been achieved.

In this particular circumstance, the cameras 10 can be controlled so that their respective status rings 50 visually communicate a not-calibrated status with a first color (e.g. green) and a calibrated status as a different second color (e.g. blue). The operator can then move the wand around until all of the status rings 50 have changed to the second color, focusing attention along the way on any cameras 10 that are have not yet changed from the green not-calibrated status to the blue calibrated status.

If desired, instead of coarsely showing each individual camera's not-calibrated status (all LED's green) versus calibrated status (all LED's blue) as one calibrates the volume, the individual LEDs of each camera's status ring 50 may be separately controlled to show the sufficiency or extent of the directional 2D coverage of the wanding for each camera. As each LED can be individually addressed, the calibration algorithm can change individual LEDs from green to blue, alerting the operator to areas of low and high wand “coverage.” With that information visually in sight, at a glance, the operator can more efficiently address the areas that require further attention.

The status ring 50 also enables a remote operator to rapidly identify a camera that requires attention to an assistant working within the volume (e.g. to rapidly re-aim a particular camera, or to reset a camera that is misbehaving, etc.).

There are many possible constructions and related uses for an illuminated status ring 50 according to the present invention. The above are just examples and are not to be construed as limiting the invention beyond the scope of the claims.

We claim:

1. In a motion capture camera suitable for use in a motion capture system having a motion capture volume, the motion capture camera comprising a housing, an illumination source for illuminating markers on a moving subject, an image sensor, and a lens for projecting an image of light reflected by the markers onto the image sensor, and a communication port for operative communication with a control system, an improvement comprising:
an illuminated status ring that is substantially concentric with and surrounds the lens, the illuminated status ring being visible to a person within the capture volume for immediately communicating an operating status at a glance; and
circuitry for changing at least one of an on/off state, intensity, and color of the illuminated status ring to communicate the operating status corresponding to a state of the camera or system containing the camera.

2. The motion capture camera of claim 1 wherein the illuminated status ring further comprises a plurality of RGB LEDs.

3. The motion capture camera of claim 2 wherein the illuminated status ring further comprises a diffusing ring that causes the plurality of RGB LEDs to appear like one annular source of colored light.

4. The motion capture camera of claim 1 wherein the illumination source for illuminating the markers comprises a plurality of marker illumination LEDs that are arranged around the lens in a ring that is concentric with the illuminated status ring.

5. The motion capture system of claim 1 wherein the operating status corresponds to a camera status of an individual motion capture camera.

6. The motion capture system of claim 5 wherein the camera status comprises one of a calibration state, an error state, a firmware update state, and a manual selection state.

7. The motion capture camera of claim 6 wherein the control system causes the illuminated status ring to change from a first color indicating that the motion capture camera is in a not-calibrated states to a second color that indicates that the motion capture camera is in a calibrated state.

8. The motion capture system of claim 1 wherein the operating status corresponds to a system status of the overall motion capture system.

9. The motion capture system of claim 8 wherein the system status is one of a live state, a recording state, and a playback state.

10. The motion capture system of claim 1 wherein the control system comprises suitable control software executing on a microprocessor within a general purpose computer.

11. A motion capture system for capturing digital data regarding motion of markers within a capture volume, comprising:
a plurality of motion capture cameras that are arranged around and aimed generally toward the capture volume; and
control software executing on a microprocessor within a general purpose computer that is connected to the plurality of motion capture cameras for controlling each motion capture camera and for receiving motion capture data output by each motion capture camera; wherein each motion capture camera comprises a housing, an illumination source for illuminating the markers with light that is reflected therefrom, an image sensor, a lens for projecting an image of the light reflected by the markers onto the image sensor, a communication port for operative connection with the control software, and a status display that is visible from within the capture volume for immediately communicating status at a glance, the control software varying the status display in accordance with an operating status.

12. The motion capture system of claim 11 wherein the status display varies in at least one of color and intensity.

13. The motion capture system of claim 11 wherein the status display comprises an RGB LED and control circuitry.

14. The motion capture system of claim 13 wherein the status display comprises a plurality of RGB LEDs that are arranged in a ring around the lens.

15. The motion capture camera system of claim 14 wherein the illumination source for illuminating the markers comprises a plurality of marker illumination LEDs that are arranged in a ring around the lens, the ring of marker illumination LEDs being concentric with the ring of RGB LEDs of the status display.

16. The motion capture system of claim 14 wherein the status display further comprises a diffusing ring that overlies the plurality of RGB LEDs and causes the status display to appear like one annular source of colored light.

17. The motion capture system of claim 11 wherein the operating status corresponds to a camera status of an individual motion capture camera.

18. The motion capture system of claim 17 wherein the camera status comprises one of a calibration state, an error state, a firmware update state, and a manual selection state.

19. The motion capture system of claim 18 wherein the control software causes the status display of each motion capture camera to change from a first color indicating that the motion capture camera is in a not-calibrated states to a second color that indicates that the motion capture camera is in a calibrated state.

20. The motion capture system of claim 11 wherein the operating status corresponds to a system status of the overall motion capture system.

21. The motion capture system of claim 20 wherein the system status is one of a live state, a recording state, and a playback state.
